(19) United States
(12) Patent Application Publication
(10) Pub. No.: US 2010/0086771 A1
(43) Pub. Date: Apr. 8, 2010

(54) Substrate for Lighting Device and Production Thereof

(75) Inventor: Yoshikazu Nageno, Kawasaki-shi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/247,412

(22) Filed: Oct. 8, 2008

(51) Int. Cl. B32B 15/04; B05D 5/06

(52) U.S. Cl. 428/332; 428/426; 427/165

(57) ABSTRACT

Disclosed is a substrate for a lighting device that includes an inorganic substrate with a coefficient of thermal expansion (TCE) of 7 to 13 ppm/K and an insulating layer. The insulating layer includes; a first transparent glass insulating layer having a TCE of 8.2 to 9.4 ppm/K; a white glass insulating layer which is on the first transparent glass insulating layer, and which contains, as white pigment, one or two or more of titanium oxide (TiO₂), aluminum oxide (Al₂O₃), silicon dioxide (SiO₂), strontium titanate (SrTiO₂), barium titanate (BaTiO₃), zinc oxide (ZnO), or magnesium aluminate (MgAl₂O₄), and has a TCE of 5.0 to 9.0 ppm/K; and a second transparent glass insulating layer which is on the white glass insulating layer, and which has a TCE of 8.2 to 9.4 ppm/K.

### FIELD OF THE INVENTION

The present invention relates to a substrate for a lighting device, and in particular to a metal based substrate. The invention also relates to a method for producing such a substrate.

### TECHNICAL BACKGROUND

Recent progress in making smaller or higher functioning lighting devices has resulted in greater heat production from the light source, and the release of which heat has become a problem. Heat conducting and dissipating metal based substrates have been used as a means for overcoming this problem. JP 2006-270002 has disclosed a circuit substrate for LED packaging composed of a metal substrate and an insulating layer.

When a circuit is formed on a metal substrate, an insulating layer is formed over the entire surface of the metal substrate on which the circuit is to be formed. In circuit substrates for lighting devices, the substrate itself will preferably have a high optical reflectance to achieve even small increases in the luminous efficiency. Insulating layers containing TiO₂ or Al₂O₃ which are commonly known as white pigments have thus been proposed. JP2006-031950 has disclosed the use of TiO₂ and the like as white pigment in the reflecting layers of plasma display panels. Here, TiO₂ and Al₂O₃ are known to lower the coefficient of thermal expansion (TCE) of glass. As such, when insulating layer compositions that contain white pigments are applied onto inorganic substrates, particularly metal substrates, that have a high TCE and are treated at elevated temperatures, a resulting problem is that the circuit substrate becomes warped due to differences in the TCE between the two. Various investigators have dealt with the problem of warping. JP2006-270002 has disclosed a circuit substrate for LED package having two insulating layers on the metal substrate to prevent cracks and warping. Particles of aluminum oxide having different configurations are added to the two insulating layers on this metal substrate. JP2003-023223 has discloses a metal substrate for resin insulated circuits that are useful in ensuring heat resistance. This metal substrate is provided with two insulating layers having different organic binder compositions. The insulating layers in these documents both involve the use of resin as binder, with no mention of the glass composition.

JPH05-251837 has disclosed a circuit substrate in which an amorphous glass layer and crystalline glass layer are sequentially laminated on the surface of a metal substrate to prevent cracks. SiO₂ glass, PbO—B₂O₃ glass, and Na₂O—CaO—SiO₂ glass are given as examples of amorphous glass, and examples of crystalline glass include glass in which at least one type of oxide frit selected from Al₂O₃, ZrO₂, CaO, PbO, TiO₂, and BaO has been blended with the above amorphous glass composition.

There is a need for providing glass insulation layers that simultaneously provide high optical reflectance while preventing warpage.

### SUMMARY OF THE INVENTION

The present invention provides a substrate for a lighting device that simultaneously provides high optical reflectance, while preventing warpage, and describes a method for producing such a substrate for a lighting device.

The substrate for a lighting device in the present invention includes an inorganic substrate with a coefficient of thermal expansion (TCE) of 7 to 13 ppm/K and an insulating layer on one surface of the inorganic substrate. The insulating layer includes: a first transparent glass insulating layer having a TCE of 8.2 to 9.4 ppm/K; a white glass insulating layer which is on the first transparent glass insulating layer, and which contains, as white pigment, one or two or more of titanium oxide (TiO₂), aluminum oxide (Al₂O₃), silicon dioxide (SiO₂), strontium titanate (SrTiO₂), barium titanate (BaTiO₃), zinc oxide (ZnO), or magnesium aluminate (MgAl₂O₄), and has a TCE of 5.0 to 9.0 ppm/K; and a second transparent glass insulating layer which is on the white glass insulating layer, and which has a TCE of 8.2 to 9.4 ppm/K.

The present invention also relates to a method for producing a substrate for a lighting device including an inorganic substrate with a coefficient of thermal expansion (TCE) of 7 to 13 ppm/K and an insulating layer. The method includes the steps of; (a) applying an insulation paste for forming a first transparent glass insulating layer having a TCE of 8.2 to 9.4 ppm/K to one surface of the inorganic substrate and firing the same; (b) applying a white glass insulating layer having a TCE of 5.0 to 9.0 ppm/K containing any one, or a combination of two or more, of titanium oxide (TiO₂), aluminum oxide (Al₂O₃), silicon dioxide (SiO₂), strontium titanate (SrTiO₂), barium titanate (BaTiO₃), zinc oxide (ZnO), or magnesium aluminate (MgAl₂O₄) as white pigment to the first transparent glass insulating layer paste and firing the same; and (c) applying the glass insulation paste for forming a second transparent glass insulating layer having a TCE of 8.2 to 9.4 ppm/K to the white insulation paste and firing the same, the insulation pastes in steps (a), (b), and (c) being fired at 700 to 950□C after the insulation paste has been dried at 100 to 400° C.

In the substrate for a lighting device and its method of production in the invention, the pigment of the white insulating layer is preferably TiO₂, the content of which is preferably 0.2% to 25.0% relative to the weight of the unfired white glass insulating layer. The first and second transparent glass insulating layers and white glass insulating layer can also further include one or two or more of SiO₂, Al₂O₃, TiO₂, ZnO, aluminum nitride (AlN), or boron nitride (BN) as inorganic filler. The first and second transparent glass insulating layers preferably have a thickness within a range of 1 to 50 μm after being fired, and the white glass insulating layer preferably has a thickness within a range of 5 to 80 μm after being fired.

### BRIEF DESCRIPTION OF THE FIGURES

FIG. 1 shows an organic substrate for a lighting device that has an insulating layer on one surface the substrate.

FIG. 2 show the warpage (labeled as B) that is expressed by the Formula (I) herein using (X) and (Y).

### DETAILED DESCRIPTION OF THE INVENTION

The substrate for a lighting device in the invention is composed of an inorganic substrate and an insulating layer on one surface thereof, wherein the insulating layer includes a first transparent glass insulating layer, a white glass insulating layer, and a second transparent glass insulating layer. Specifically, as illustrated in FIG. 1, the substrate 6 for a lighting device has an insulating layer 5 provided on one surface of the inorganic substrate 1. The insulating layer 5 is composed of a first transparent glass insulating layer 2, a white glass insulating layer 3, and a second transparent glass insulating layer 4, in the order starting closest to the inorganic substrate 1. Of the layers forming the insulating layer, the first and second transparent glass insulating layers are preferably 1 to 50 μm thick after being fired, and the white glass insulating layer is preferably 5 to 80 μm thick after being fired.

The first transparent glass insulating layer and second transparent glass insulating layer included in the substrate for a lighting device in the invention may be the same or different. Accordingly, the conditions of the first transparent glass insulating layer and second transparent glass insulating layer, such as the composition and film thickness, will sometimes be the same and will sometimes be different. In the present invention, the first transparent glass insulating layer and second transparent glass insulating layer will preferably have the same film thickness.

The first and second transparent glass insulating layers will preferably have a TCE of 8.2 to 9.4 ppm/K. The TCE of the white glass insulating layer will also be 5.0 to 9.0 ppm/K, and preferably 7.0 to 9.0 ppm/K.

The substrate for a lighting device in the invention can be used as a reflecting plate in a lighting device or a substrate for forming a circuit in a lighting device and providing a light source, for example as LED.

The inorganic substrate of the present invention has high TCE. The metallic substrate used is not particularly limited, and may comprise, for instance, stainless steel, carbon steel, copper, copper alloys, nickel, nickel alloys, titanium or the like. The ceramic substrate used is not particularly limited, and may comprise, for instance, alumina, boron nitride, aluminum nitride, zirconia, magnesia or the like.

The TCE of the substrate used in the present invention is preferably of 7 to 13 ppm/K, more preferably of 8 to 11 ppm/K. Within the above ranges, TCE differences with the insulation layer can be easily reduced, and the occurrence of defects is dramatically suppressed.

Substrates having high thermal conductivity are particularly preferred for packaging high heat-generating electronic components such as LED or the like. Ordinarily, metallic substrates are preferably used from the viewpoint of heat dissipation. Although not particularly limited, thermal conductivity is preferably no smaller than 1 W/mK, more preferably no smaller than 10 W/mK. Within the above ranges, heat can be efficiently dissipated from the mounted electronic component.

The first transparent glass insulating layer and second transparent glass insulating layer are formed from insulation pastes, and the white glass insulating layer is formed from a white insulation paste. The constituent elements of the insulation pastes of the present invention are glass frit, a resin binder, and a solvent. The white insulation paste further comprises a white pigment. Particularly in the present invention, the glass frit included in the white glass layer is preferably such that a white pigment is further added to the same glass composition as the above first and second transparent glass insulating layers.

(A) Glass Frit

The insulation paste of the present invention contains an inorganic binder in the form of glass frit. The glass frit contains 0.1 to 10 wt % of B₂O₃ based on the total weight of the glass frit.

Ordinarily, when an insulation paste is coated onto a substrate and is fired, the longer the firing time, the greater the warpage becomes. The TCE of glass is normally lower than that of a metallic substrate made of, for instance, stainless steel, and hence a convex warpage forms as a result. Addition of an alkaline earth oxide having a large ionic radius, such as barium oxide or strontium oxide, is effective in suppressing the above phenomenon, as it allows bringing the TCE of the formed insulation layer closer to the TCE of the metallic substrate or the ceramic substrate. Substrate warpage, and occurrence of defects such as cracks or the like is suppressed as a result.

Also, substrate warpage, and occurrence of defects such as cracks or the like, are suppressed by inhibiting the formation of a low-TCE crystal phase in the glass, as a result the thermal treatment. Ordinarily, adding B₂O₃ tends to inhibit crystallization of glass. Also, the presence of B₂O₃ allows reducing the glass transition temperature and the softening temperature of glass frit, which in turn makes it possible to lower the firing temperature. The lower the firing temperature, the less likely it is that defects occur on account of TCE differences.

The mechanism whereby B₂O₃ elicits the above effect is uncertain, but one conjectured factor is the presence of celsian (BaAl₂Si₂O₈) having a low TCE. Celsian tends to form when B₂O₃ is not present. The TCE of celsian, of 2.3 ppm/K, is low, and thus the formation of celsian as a crystal phase in the glass frit is believed to exacerbate substrate warpage. On the other hand, substrate warpage is presumably reduced through inhibition of crystallization of celsian by adding B₂O₃.

In the present application, the content of B₂O₃ is preferably no greater than 10 wt % relative to the total weight of glass frit. An excessive B₂O₃ content tends to impair chemical durability. By contrast, an excessively small B₂O₃ content may prevent the effect of B₂O₃. Accordingly, the content lower limit in the glass frit is 0.1 wt %. The content of B₂O₃ is preferably not lower than 0.5 wt %, more preferably not lower than 1.5 wt %, and most preferably not lower than 2.0 wt %. As regards the upper limit, the content of B₂O₃ is preferably no greater than 9.5 wt %, more preferably no greater than 9.0 wt %, and most preferably, no greater than 8.0 wt %.

Components other than B₂O₃ that can be used in the glass frit are not particularly limited, and include, for instance, various glass types such as Si-based glass, Bi-based glass, Pb-based glass or the like. An amorphous glass is preferably used in terms of preventing cracks in the insulation layer. Cracking is less likely to occur when using an amorphous glass than when using a crystalline glass.

Examples of preferred glass compositions include, for instance, a glass frit comprising 20 to 60 wt % of SiO₂, 10 to 60 wt % of alkaline earth metal oxide, 5 to 30 wt % of ZnO, 0.5 to 7 wt % of ZrO₂, 0.1 to 10 wt % of B₂O₃, and 0 to 14 wt % of Al₂O₃ based on the total weight of the glass frit. The above glass frit may also comprise any components other than the above-listed ones.

Silica (SiO₂) has the function of forming a network in the glass frit. The content of silica is preferably of 20 to 60 wt %, more preferably of 40 to 60 wt %, and yet more preferably off 45 to 55 wt %, based on the total weight of the glass frit. When silica is excessive, the softening point of glass rises. Too little silica promotes glass crystallization and may impair the sealing performance of the formed insulation layer.

Zinc oxide (ZnO) lowers the softening point, increases the flowability of glass, and enhances the electric characteristics of the insulation layer. Added in excess, ZnO lowers the TCE of glass.

The TCE of the insulation layer can be further brought close to that of the metal substrate or of the ceramic substrate when ZnO is present together with an alkaline earth metal in the form of MgO, CaO, SrO or BaO. Preferred contents in this case are 0 to 5 wt % of MgO, 0 to 8 wt % of CaO, 5 to 20 wt % of SrO and 15 to 45 wt % of BaO, based on the total weight of the glass frit.

Zirconia (ZrO₂) increases the flowability of glass, and enhances the electric characteristics of the insulation layer. Adding zirconia allows lowering the dissipation factor and increasing dielectric properties, while reducing blistering. Zirconia has low compatibility with glass systems, and hence it is difficult to mix substantial amounts of zirconia into glass. With that in mind, the addition amount of zirconia is preferably 0.1 to 5 wt %, more preferably 1 to 4 wt %.

Adding alumina (Al₂O₃) allows enhanced chemical durability. However, alumina functions as a crystallization promoter. If alumina is added, therefore, the amount thereof is preferably 0.1 to 10 wt %, more preferably 0.5 to 5 wt %.

The glasses are prepared by conventional glass-making techniques, i.e., by mixing the desired components in the desired proportions and heating the mixture to form a melt. As is well known in the art, heating is conducted to a peak temperature and for a time such that the melt becomes entirely liquid and homogeneous

The glasses are prepared by conventional glass-making techniques, i.e., by mixing the desired components in the desired proportions and heating the mixture to form a melt. As is well known in the art, heating is conducted to a peak temperature and for a time such that the melt becomes entirely liquid and homogeneous.

In preparing the compositions of the invention, the components are premixed by shaking in a polyethylene jar with plastic balls and then melted in a platinum or ceramic container at about 1500° C. The melt is heated at the peak temperature for a period of at least one hour. Heating for less than one hour would result in inhomogeniety in the glass. A heating time of 1.5 to 2 hours is preferred.

The melt is then poured into cold water. The maximum temperature of the water during quenching is kept below 120° F. by increasing the volumetric ratio of water to melt. The crude frit after separation from water is freed to residual water by drying in air or by displacing the water with methanol. The crude frit in slurry form is then ball milled in alumina containers using alumina balls. Alumina picked up by the materials, if any, is not within observable limits as measured by x-ray diffraction analysis.

After discharging the milled frit slurry from the mill, excess solvent is removed by decantation and the frit powder is air dried at 130° C. The dried powder is then screened through a 325 standard mesh screen to remove any large particles.

In the cases of transparent and white glass insulating pastes, the content of the glass frit in the insulation paste is preferably 40 to 90.0 wt %, and more preferably 50.0 to 85.0 wt % based on the total weight of the insulation paste.

(B) Organic Binder

An organic binder is used to allow constituents such as glass frit to be dispersed in the paste. The organic binder is burned off in a sintering process at elevated temperature.

Examples of the organic binders include poly (vinyl butyral), poly (vinyl acetate), poly (vinyl alcohol), cellulosic polymers such as methyl cellulose, ethyl cellulose, hydroxyethyl cellulose, methylhydroxyethyl cellulose, atactic polypropylene, polyethylene, silicon polymers such as poly (methyl siloxane), poly (methylphenyl siloxane), polystyrene, butadiene/styrene copolymer, polystyrene, poly (vinyl pyrrolidone), polyamides, high molecular weight polyethers, copolymers of ethylene oxide and propylene oxide, polyacrylamides, and various acrylic polymers such as sodium polyacrylate, poly (lower alkyl acrylates), poly (lower alkyl methacrylates) and various copolymers and multipolymers of lower alkyl acrylates and methacrylates. Copolymers can be ethyl methacrylate and methyl acrylate and terpolymers can be ethyl acrylate, methyl methacrylate and methacrylic acid.

The molecular weight of the organic binder is not particularly limited, but is preferably less than 50,000, more preferably less than 25,000, and even more preferably less than 15,000.

The content of the organic binder in the insulation paste, but is not limited to, preferably 0.5 to 20 wt %, and more preferably 1 to 5 wt % based on the total weight of the insulation paste.

(C) Solvent

The primary purpose for using an organic solvent is to allow the dispersion of solids contained in the composition to be readily applied to the substrate. As such, the organic solvent is preferred to first of all be one that allows the solids to be dispersed while maintaining suitable stability. Secondly, the rheological properties of the organic solvent are preferred to endow the dispersion with favorable application properties.

The organic solvent may be a single component or a mixture of organic solvents. The organic solvent that is selected is preferred to be one in which the polymer and other organic components can be completely dissolved. The organic solvent that is selected is preferred to be inert to the other ingredients in the composition. The organic solvent is preferred to have sufficiently high volatility, and is preferred to be able to evaporate off from the dispersion even when applied at a relatively low temperature in the atmosphere. The solvent is preferred not to be so volatile that the paste on the screen will rapidly dry at ordinary temperature during the printing process.

The boiling point of the organic solvent at ordinary pressure is preferred to be no more than 300° C., and preferably no more than 250° C.

Specific examples of organic solvents include aliphatic alcohols and esters of those alcohols such as acetate esters or propionate esters; terpenes such as turpentine, terpineol, or mixtures thereof; ethylene glycol or esters of ethylene glycol such as ethylene glycol monobutyl ether or butyl cellosolve acetate; butyl carbitol or esters of carbitol such as butyl carbitol acetate and carbitol acetate; and Texanol (2,2,4-trimethyl-1,3-pentanediol monoisobutyrate).

The content of the solvent in the insulation paste, but is not limited to, preferably 10 to 50 wt %, and more preferably 20 to 40 wt % based on the total weight of the insulation paste.

(D) White pigment

Examples of White pigment used in the present invention are titanium dioxide (TiO₂), aluminum oxide (Al₂O₃), silicon dioxide (SiO₂), strontium titanate (SrTiO₃), barium titanate (BaTiO₃), zinc oxide (ZnO) or magnesium aluminate (MgAl₂O₄), or the combination thereof. TiO₂ is preferable as the white pigment. The content of the white pigment in the insulation paste is preferably 0.2 % to 25.0 % by weight of the white glass insulation paste (i.e. by weight of the white glass insulation layer before sintered).

(E) Additives

The insulation paste may optionally comprise additives such as inorganic fillers, dispersants, stabilizers, plasticizers, stripping agents, defoamers, wetting agents or the like.

The inorganic filler is preferably added to the insulation paste for the purpose of adjusting the coefficient of thermal expansion, increasing thermal conductivity, and also for coloring, as a pigment. The inorganic filler that is added is not particularly limited, and may be, for instance, silica (SiO₂), alumina (Al₂O₃), titania (TiO₂), zinc oxide (ZnO), aluminum nitride (AlN) or boron nitride (BN), singly or in combinations of two or more.

When the inorganic filler is added to the insulation paste, the formed insulation layer comprises a component derived from the inorganic filler. However, the inorganic component from the glass frit and the inorganic component from the inorganic filler are not compatible and do not blend harmoniously at ordinary firing temperatures. Instead, the component from the inorganic filler becomes dispersed in the component from the glass frit. As a result, it is possible to tell apart whether the component derives from the glass frit or from the inorganic filler, even when the glass frit and the inorganic filler comprise both the same component.

The content of the inorganic filler in the insulation paste, is preferably, but not limited to 0 to 30 wt %, and more preferably 3 to 20 wt % based on the total weight of the insulation paste.

The insulation paste is obtained by mixing the constituents of the paste. In the present invention, the pastes for the first and second transparent glass insulating layers and the paste for the white glass insulating layer are prepared. The pastes for the first and second transparent glass insulating layers can be obtained by measuring out and the desired amounts of the above glass frit, organic binder, solvent, and additives as needed, and appropriately blending them. The pastes for the first and second transparent glass insulating layers may be the same or different. The pastes are preferably the same. The paste for the white glass insulating layer can be obtained by measuring out the desired amounts of the above glass frit, organic binder, white pigment, solvent, and additives as needed, and appropriately blending them. The pastes are conveniently prepared on a three-roll mill. A preferred viscosity for these compositions is approximately 100 to 200 Pa s measured on a Brookfield HBT viscometer using a #5 spindle at 10 rpm.

The method for producing a substrate for a lighting device including an inorganic substrate having a coefficient of thermal expansion (TCE) of 7 to 13 ppm/K and an insulating layer includes the following steps.

The insulation pastes for the insulating layers are first prepared by the following procedures.

In step (a), an insulation paste for forming the first transparent glass insulating layer having a TCE of 8.2 to 9.4 ppm/K is then applied onto one surface of the inorganic substrate, and the insulation paste is then dried and fired.

In step (b), a white glass paste having a TCE of 5.0 to 9.0 ppm/K is then applied, dried, and fired on the first transparent glass insulating layer. Titanium oxide (TiO₂), aluminum oxide (Al₂O₃), silicon dioxide (SiO₂), strontium titanate (SrTiO₂), barium titanate (BaTiO₃), zinc oxide (ZnO), or magnesium aluminate (MgAl₂O₄) is preferably used as the white pigment in the present invention. These materials may be used individually or in mixtures of two or more.

In step (c), a glass insulation paste for forming the second transparent glass insulating layer having a TCE of 8.2 to 9.4 ppm/K is applied, dried, and fired on the white glass insulating layer.

In the present invention, screen printing may be preferably used as an application method of steps (a) to (c). In case screen printing is used, the paste is required to have appropriate viscosity so that they can be passed through the screen readily. In addition, the paste is preferred to thixotropic in order that they set up rapidly after being screened, thereby giving good resolution. While the rheological properties are of primary importance, the organic medium is preferably formulated also to give appropriate wettability of the solids and the substrate, good drying rate, dried film strength sufficient to withstand rough handling, and good firing properties. Satisfactory appearance of the fired composition is also important. Typical method is screen printing, however the method is not limited to screen printing.

In the steps (a), (b) and (c), the printed insulation layers are dried and sintered. Drying condition is, but is not limited to, 100 to 400° C. for 10 to 60 minutes. The material that has been formed is sintered. The sintering temperature is not limited, but the present invention is especially beneficial when the paste is sintered at high temperature such as 700 to 950° C. Even if such a high temperature is adapted as the sintering condition, the defects caused by the difference of TCEs between the substrate and the insulation layer are effectively prevented. During the sintering process, the glass powder melts and becomes firmly attached to the substrate.

The drying and firing procedures are not particularly limited, and procedures that are commonly used in this technical field may be employed. For example, the material may be dried in an oven and then fired in a suitable firing furnace (such as a belt furnace or box furnace).

Procedures for drying and firing the various insulation pastes in steps (a), (b), and (c) are employed in the production method of the invention, but the invention is not limited to these. The various insulation pastes may be printed on the inorganic substrate, and the insulation layer as a whole may then be dried and fired.

Cracks caused by TCE mismatch can be better prevented the closer the TCE of the formed insulation layer is to the TCE of the substrate. Specifically, the TCE of the formed insulation layer is preferably of 8.2 to 9.4 ppm/K.

The formed insulation layer comprises 0.1 to 10 wt % of B₂O₃ based on the total weight of the glass component. This affords, as a result, the above-described effects of substrate warpage suppression, crack prevention and so forth. In the present application, the term “glass component” denotes the component in the insulation layer that derives from glass frit. Although that component is comprised in the insulation paste as powder-like glass frit, firing results in component integration, whereupon the glass component in the insulation layer ceases to be powder-like. For differentiation purposes, therefore, the component formed from the glass frit is referred to as the “glass component”.

The composition of the glass component in the insulation layer corresponds to the composition of the glass frit, and thus the above explanation regarding the glass frit applies equally to the glass component.

After formation of the insulation layer, various materials such as electronic circuits, electrodes, electronic components or the like are arranged on the insulation layer in accordance with the use of the electronic member. Conventional technologies can be used for forming these materials, although, needless to say, newly developed technologies may be applied as well to that end.

### EXAMPLES

Warping which occurred after the transparent glass insulating layers and/or white glass insulation layer and SUS substrate had been fired was first studied (warp test). The appropriate amount of white pigment (TiO₂) added to the white glass insulating layer was then studied (optical reflectance test).

### 1. Preparation of Glass Paste

Glass frit and inorganic filler were measured and mixed. The composition of the glass frit is given in Table 1. The ingredients were dry milled by ball milling, and the particle size of the glass powder was then adjusted on a fluidized classifier. 0.51 g of ethyl cellulose dissolved in 3.41 g of terpineol was diluted with 3.92 g of butyl carbitol acetate (BCA), 0.16 g of the dispersant Disperbyk-180 (BYK Chemie USA Inc.) was added, the ingredients were vigorously stirred, 13.43 g glass powder as well as 3.06 g of SiO₂ and 0.51 g of TiO₂ as inorganic filler were added to the resulting resin solvent, and the ingredients were thoroughly mixed in a three-roll mixer to prepare insulation paste.

TABLE 1

| Glass Frit | composition (wt %) |
|---|---|
| SiO₂ | 32.1 |
| Al₂O₃ | 0.7 |
| ZrO₂ | 3.5 |
| CaO | 5.5 |
| ZnO | 15.6 |
| BaO | 27.1 |
| SrO | 13.4 |
| B₂O₃ | 2.0 |
| Total | 100 |

### 2. Formation of Insulating Layer

The transparent glass insulating paste or white glass insulating paste was printed onto an SUS substrate (SUS 430; TCE: 10.2 ppm/C), dried for 10 min at 150° C., and fired for 15 min at 850° C. The SUS substrate was 50 mm long by 50 mm wide and was 0.4 mm thick. The insulation paste was 48 mm long by 50 mm wide, and the thickness in one printing operation was a thickness sufficient to ensure that the fired insulation layer would be 20 μm thick. There were four types of insulating layer patterns, including a three-layered structure composed of a transparent glass insulating layer (20 μm thick), a white glass insulating layer (40 μm thick), and a transparent glass insulating layer (20 μm thick), a two-insulating layer structure composed of a transparent glass insulating layer (20 μm thick) and a white glass insulating layer (40 μm thick), a one insulating layer structure composed of a white glass insulating layer (80 μm thick), and a one insulating layer structure composed of a white glass insulating layer (40 μm thick). The thickness of the insulating layers is the value after being fired. These four different patterns of glass insulating layers were printed onto stainless steel substrates and fired for 15 min at 850° C. For the two-insulating layer pattern composed of a transparent glass layer and a white glass layer, the paste for the transparent glass layer was printed and fired for 15 min at 850° C., and the paste for the white glass layer was printed and fired thereon under the same conditions. For the three-layered pattern composed of a transparent glass layer, white glass layer, and transparent glass layer, layers were applied and fired in the same manner as the two insulating layer pattern, another transparent glass layer paste was printed under the same conditions, and the transparent glass layer paste was fired.

### 3. Measurement

### 3-1. Coefficient of Thermal Expansion (TCE)

The coefficient of thermal expansion is defined in the JIS Glossary 331 and is a coefficient indicating thermal expansion per 1° C. In this application, the coefficient of thermal expansion from 50 to 350° C. was calculated based on measurement from room temperature to around the glass transition point under a 2 g load using a TMA-SS by Seiko Instruments Inc.

### 3-2. Warpage

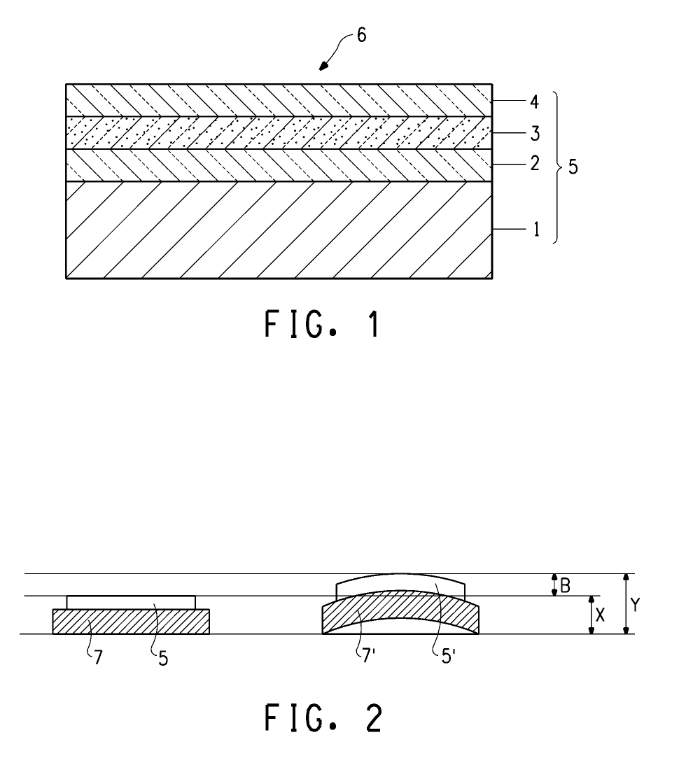

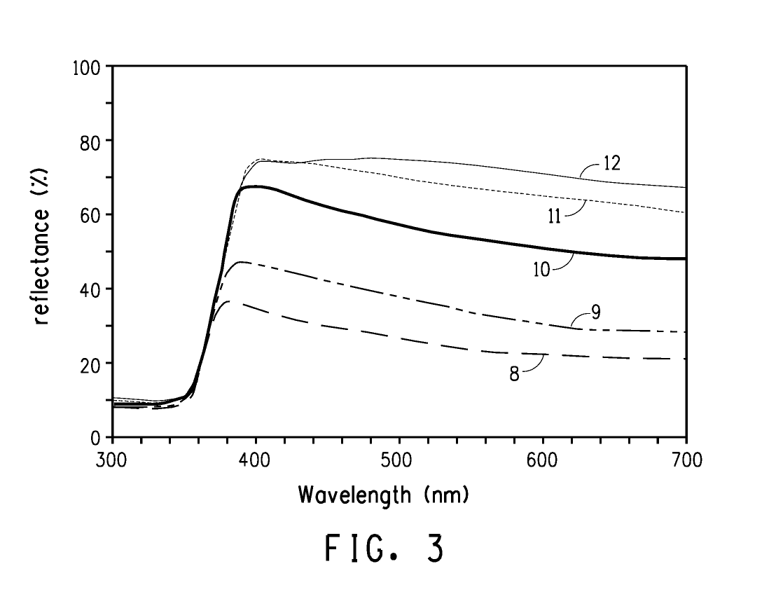

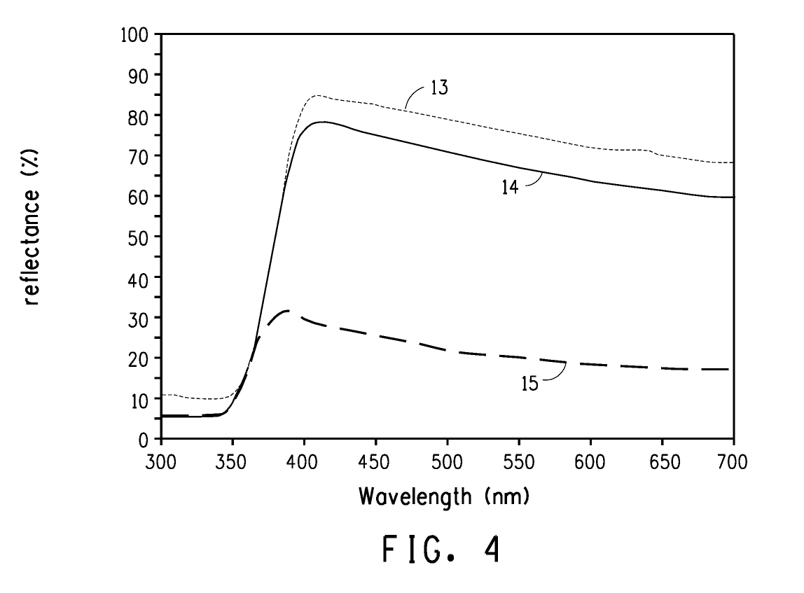

To measure the expansion match to the substrate in conditions approximating those in actual use, the following procedure was used. The thickness of alumina substrates are measured using a digital micrometer. The dielectric pastes are printed in a pattern having a hole in the center for measuring height change as the layers were built up and fired. One layer was printed and dried then fired in the belt furnace at 850° C., 15 minutes one layer after another. Then the height change from the original is measured. The change in substrate height before and after firing was measured to study substrate warping after being fired. Here, the warpage (B) was obtained by subtracting the unwarped substrate thickness (X) from the distance (Y) between the apex of the fired insulating layer and the foot point of the SUS substrate. That is, the warpage (B) is expressed by the following Formula (I) using (X) and (Y) in FIG. 2. The value (X) is assumed that the sum of the unwarped SUS substrate (7) thickness and the unwarped insulating layer (5) thickness after firing. However, an inorganic substrate with insulating layer warps in most case so that the value of (X) is calculated as the sum of the SUS substrate (7′) thickness and the insulating layer (5′) thickness after firing.

Warpage (B)=(Y)+(X) (I)

### 3-3. Reflectance

TiO₂ was further added as white pigment to glass paste having the composition of Table 1 so as to prepare white glass insulating pastes having a different total content of TiO₂ (0.21%, 0.35%, 7.0%, 10.5%, and 14.0%) relative to the paste weight. These white glass insulating pastes were used to form one white layer (40 μm) and three layers of glass insulating layers (transparent 20 μm+white 40 μm+transparent 20 μm) on stainless steel substrates, and the optical reflectance of the insulating layers was studied. The optical reflectance was measured by directing 300 to 700 nm light on each insulating layer and measuring the optical reflectance at each wavelength (instrument: UV-2550, by Shimadzu Seisakusho). The optical reflectance was also similarly measured in each of one white layer (40 μm), one transparent layer (20 μm), and three layers (transparent 20 μm+white 40 μm+transparent 20 μm).

### 4. Results

### 4-1. Results for Warpage

The warpage of substrates on which insulating layers had been formed was studied according to the procedure described in the section on the formation of the insulating layers above. The results are given in Table 2. Compared to the 40 μm thick white glass insulating layer (substrate with one insulating layer), the substrates having a two-insulating layer structure had higher warpage, whereas the warpage was lower in substrates having a triple-insulating layer structure. The warpage in the substrates having a triple-insulating layer structure was also about half that of the substrates with the white single insulating layer structure having the same thickness (substrates with an 80 μm thick white single insulating layer). Substrates with triple insulating layer structures, substrates with a one white glass insulating layer structure (80 μm thick), and substrates with a one white glass insulating layer structure (40 μm thick) were then repeatedly fired at 15 min, 30 min, 45 min, 60 min and 15 min intervals to study warpage after each firing time. The results are given in Table 3. Compared to 40 μm thick white glass insulating layers (substrates with a one insulating layer structure), the other substrates had lower warpage of 0.04 to 0.05 mm after all firing times. The warpage of substrates with three-layered insulating layer structures was about half that of substrates having a single white insulating layer structure of the same film thickness (80 μm).

TABLE 2

| | three layers | | | |
|---|---|---|---|---|
| | (transparent 20 + | | | |
| Insulating | white 40 + | two layers | one white | one white |
| layer | transparent | (transparent 20 + | layer | layer |
| thickness | 20 μm) | white 40 μm) | 80 μm | 40 μm |
| Warpage | 0.30 | 0.39 | 0.60 | 0.36 |
| (mm) | | | | |

TABLE 3

| | | three layers | | |
|---|---|---|---|---|
| | | (20 + 40 + | one white layer | one white layer |
| Firing time | | 20 μm) | (80 μm) | (40 μm) |
| Warpage | 15 min | 0.30 | 0.60 | 0.36 |
| (mm) | | | | |
| | 30 min | 0.26 | 0.55 | 0.30 |
| | 45 min | 0.23 | 0.50 | 0.28 |
| | 60 min | 0.21 | 0.48 | 0.25 |

### 4-2. Results for Reflectance

FIG. 3 shows the optical reflectance of white insulating layers formed with glass insulating pastes having a different content of TiO₂ as the white pigment (0.21%, 8; 0.35%, 9; 7.0%, 10; 10.5%, 11; and 14.0%,12). The addition of 0.35%or more of TiO₂ resulted in a reflectance of about 30% or more in the 360 to 700 nm wavelength region. The addition of 7.0% or more resulted in increasing reflectance about 50% or more. FIG. 4 FIG. 4 shows the results that were obtained from measuring the optical reflectance in substrates in which the insulating layers were one white layer (40 μm) 13, a one transparent layer (20 μm) 14, and three layers (transparent 20 μm+white 40 μm+transparent 20 μm) 15. The substrate with the three insulating layers had about the same reflectance as the substrate with one white insulating layer. Higher optical reflectance can be achieved and circuit substrate warpage can be prevented using a structure in which a white glass insulating layer is sandwiched between transparent glass insulating layers having a high TCE such as that noted above, despite the addition of TiO₂ as white pigment to the insulating layers.

What is claimed is:

1. A substrate for a lighting device including an inorganic substrate with a coefficient of thermal expansion (TCE) of 7 to 13 ppm/K, and an insulating layer on one surface of the inorganic substrate, wherein
the insulating layer comprises;
(1) a first transparent glass insulating layer having a TCE of 8.2 to 9.4 ppm/K,
(2) a white glass insulating layer which is on the first transparent glass insulating layer, and which contains, as white pigment, one or two or more of titanium oxide (TiO₂), aluminum oxide (Al₂O₃), silicon dioxide (SiO₂), strontium titanate (SrTiO₂), barium titanate (BaTiO₃), zinc oxide (ZnO), or magnesium aluminate (MgAl₂O₄), and has a TCE of 5.0 to 9.0 ppm/K, and
(3) a second transparent glass insulating layer which is on the white glass insulating layer, and which has a TCE of 8.2 to 9.4 ppm/K.

2. The substrate for a lighting device according to claim 1, wherein the content of the white pigment is 0.2% to 25.0% of the TiO₂ relative to the weight of the unfired white glass insulating layer.

3. The substrate for a lighting device according to claim 1, wherein the first and second transparent glass insulating layers and white glass insulating layer further comprise one or two or more of SiO₂, Al₂O₃, TiO₂, ZnO, aluminum nitride (AlN), or boron nitride (BN) as inorganic filler.

4. The substrate for a lighting device according to claim 1, wherein the first and second transparent glass insulating layers have a thickness within a range of 1 to 50 μm after being fired, and the white glass insulating layer has a thickness within a range of 5 to 80 μm after being fired.

5. A method for producing a substrate for a lighting device including an inorganic substrate with a coefficient of thermal expansion (TCE) of 7 to 13 ppm/K and an insulating layer, the method comprising the steps of;
(a) applying an insulation paste for forming a first transparent glass insulating layer having a TCE of 8.2 to 9.4 ppm/K to one surface of the inorganic substrate and firing the same;
(b) applying a white glass insulation paste having a TCE of 5.0 to 9.0 ppm/K comprising, as white pigment, one or two or more of titanium oxide (TiO₂), aluminum oxide (Al₂O₃), silicon dioxide (SiO₂), strontium titanate (SrTiO₂), barium titanate (BaTiO₃), zinc oxide (ZnO), or magnesium aluminate (MgAl₂O₄) to a first transparent glass insulating layer paste and firing the same; and
(c) applying the glass insulation paste for forming a second transparent glass insulating layer having a TCE of 8.2 to 9.4 ppm/K to the white insulation paste and firing the same,
the insulation paste in steps (a), (b), and (c) being fired at 700 to 950° C. after the insulation paste has been dried at 100 to 400° C.

6. The method for producing a substrate for a lighting device according to claim 5, wherein the content of the white pigment is 0.2% to 25.0% of the TiO₂ relative to the weight of the unfired white glass insulating layer.

7. The method for producing a substrate for a lighting device according to claim 5, wherein the first and second transparent glass insulating layers and white glass insulating layer further comprise one or two or more of SiO₂, Al₂O₃, TiO₂, ZnO, AlN, or boron nitride (BN) as inorganic filler.

8. The method for producing a substrate for a lighting device according to claim 5, wherein the first and second transparent glass insulating layers have a thickness within a range of are 1 to 50 μm after being fired, and the white glass insulating layer has a thickness within a range of 5 to 80 μm after being fired.
